(19) United States
(12) Patent Application Publication
(10) Pub. No.: US 2023/0231789 A1
(43) Pub. Date: Jul. 20, 2023

(54) NETWORK QUALITY TESTING

(71) Applicant: Level 3 Communications, LLC, Broomfield, CO (US)

(72) Inventors: Kenneth BROOKMAN, Denver, CO (US); David PIPER, Denver, CO (US)

(73) Assignee: Level 3 Communications, LLC, Broomfield, CO (US)

(21) Appl. No.: 18/050,156

(22) Filed: Oct. 27, 2022

Related U.S. Application Data
(60) Provisional application No. 63/300,401, filed on Jan. 18, 2022.

(51) Int. Cl. H04L 43/0864; H04L 43/0817; H04L 43/106; H04L 43/091

(52) U.S. Cl. CPC H04L 43/0864; H04L 43/0817; H04L 43/106; H04L 43/091

(57) ABSTRACT

Systems and methods for network quality testing are provided. Synthetic traffic may be sent through a first flow path and a second flow path. The second flow path includes a portion apportionable to the first flow path, internal to a server, and a portion apportionable to an external flow path, external to the server. Durations of traffic traveling through the first flow path and the second flow path are compared to determine the portion of the second flow path apportionable to the external flow path. In an example, time stamping may be performed by component(s) of the server, such as a kernel, to determine the durations of the traffic traveling through the first flow path and the second flow path.

### CROSS-REFERENCE TO RELATED APPLICATIONS

This application claims the benefit of U.S. Provisional Application No. 63/300,401 filed Jan. 18, 2022, entitled “Network Quality Testing,” which is incorporated herein by reference in its entirety.

### BACKGROUND

Network quality impacts users of individual network devices and network service providers. For example, the quality of a network may influence a speed at which an application running on a device communicates across the network. Additionally, a network may be selected based on network quality. As more devices utilize networks, determination and testing of network quality is important to provide the best service to these devices. Quality of a network may include aspects such as speed, packet loss, jitter, and latency. These aspects of network quality can be used in network diagnostics and network selection. Thus, testing of network quality provides information desirable for efficient functionality of networked devices.

It is with respect to these and other general considerations that the aspects disclosed herein have been made. Also, although relatively specific problems may be discussed herein, it should be understood that the examples should not be limited to solving the specific problems identified in the background or elsewhere in this disclosure.

### SUMMARY

Examples of the present disclosure describe systems and methods for network quality testing. In an aspect, a computer-implemented method for testing network quality is disclosed. The computer-implemented method includes sending a first packet through a first path, wherein the first path is internal to a server and includes an interface card and measuring an internal duration of the first packet traveling through the first path at a first time. The method also includes sending a second packet through a second path, wherein the second path includes a test point external to the server and measuring an external duration of the second packet traveling through the second path at a second time. Based on the measured internal duration, the first time, and the second time, the method includes determining an estimated internal duration at the second time. Further, the method includes determining a network quality duration by comparing the estimated internal duration with the external duration.

In an example, comparing the estimated internal duration with the external duration includes subtracting the estimated internal duration from the external duration. In another example, the first path further includes a kernel and a device driver. In a further example, the measured internal duration is determined based on a first time stamp recorded by the kernel as the first packet flows from the kernel to the interface card and a second time stamp recorded by the kernel as the first packet flows to the kernel from the interface card. In yet another example, the first time is when the kernel records the first time stamp. In still a further example, the external duration is measured based on a third time stamp recorded by the kernel as the second packet flows from the kernel to the test point and a fourth time stamp recorded by the kernel as the second packet flows to the kernel from the test point; and wherein the second time is when the kernel records the third time stamp. In another example, the method further includes reporting the network quality duration to a different server.

In another aspect, a computer-implemented method for testing network quality is disclosed. The computer-implemented method includes sending a first packet through an internal flow path internal to a server and measuring a first duration for the first packet associated with a first time. The method also includes sending a second packet through the internal flow path and measuring a second duration for the second packet associated with a second time. Additionally, the method includes sending a third packet through an external flow path, the external flow path including a test point external to the server and measuring a third duration for the third packet associated with a third time. Further, the method includes estimating an internal duration associated with the third time, based on the first duration, the first time, the second duration, and the second time, and calculating a network quality duration based on the third duration and the estimated internal duration.

In an example, estimating the internal duration is further based on a weighted average of the first duration and the second duration. In another example, the weighted average is further based on a first time difference between the first time and the third time and a second time difference between the second time and the third time. In a further example, the internal flow path includes a kernel, a device driver, and an interface card. In yet another example, sending the first packet through the internal flow path includes sending the first packet to one of: an internet protocol (IP) address measuring the first duration and the second duration is based on time stamping by a kernel of the server. In another example, the method further includes validating the network quality duration based on time stamps by an interface card of the server.

In a further aspect, a system for testing network quality is disclosed. The system includes a test point and a server. The server includes an interface card, at least one processor, and memory storing instructions that, when executed by the at least one processor, cause the system to perform a set of operations. The set of operations includes sending a first packet through a first path, wherein the first path is internal to a server and includes an interface card, and measuring an internal duration of the first packet traveling through the first path at a first time. The set of operations also includes sending a second packet through a second path, wherein the second path includes a test point external to the server, and measuring an external duration of the second packet traveling through the second path at a second time. Based on the measured internal duration, the first time, and the second time, the set of operations includes determining an estimated internal duration at the second time. Further, the set of operations includes determining a network quality duration by subtracting the estimated internal duration from the external duration.

In an example, the server further includes an application and a kernel, and wherein the first path includes the kernel, but not the application. In another example, the application is on a virtual machine on the server. In a further example, the virtual machine also includes a guest operating system. In yet another example, the first path is a round trip path from a kernel of the server to the interface card to the kernel. In still a further example, the second path is a round trip path from the kernel through the interface card to the test point and back to the kernel through the interface card.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1A depicts an example system for quality testing of a network.

FIG. 1B depicts an example system for quality testing a network between a server and a test point.

FIG. 2 depicts an example system for quality testing a network.

FIG. 3 depicts another example system for quality testing a network.

FIGS. 4A-4B depict graphical examples of estimating quality of a network.

FIGS. 5-6 depict other graphical examples of estimating quality of a network.

FIG. 7 depicts an example operating environment.

FIG. 8 depicts an example method for quality testing a network.

FIG. 9 depicts another example method for quality testing a network.

### DETAILED DESCRIPTION

Network quality can be used to assess a network, including for network diagnostics and network selection. For example, a lower quality network may be flagged for diagnostics. As another example, a higher quality network may be prioritized over a lower quality network. Thus, testing of network quality provides information desirable for efficient functionality of networked devices.

Testing of a network often involves a speed test for traffic from point to point across a network. This testing may be concerned specifically with the network. For example, point-to-point testing may factor out any time associated with components of chassis, servers, devices, etc. such that only the quality of the network (e.g., including the links, switches, etc. of the network) is impacting the test.

In some examples, overhead associated with components of a chassis, server, device, etc. may be factored out by using specific hardware. For example, certain network interface cards (NICs) are capable of creating a timestamp for traffic being sent and received through the NIC. By timestamping traffic at a NIC, the last component of a server, all other overhead associated with the server is factored out (e.g., not considered) in the round-trip time of traffic in a point-to-point test. Requiring a NIC to timestamp traffic, however, introduces a hardware constraint for network quality testing.

Solutions to network quality testing may instead include a software-based solution. A software-based solution allows for network quality testing using servers with any configuration and any type of NIC. Thus, the present solution is not limited by a server having specific hardware. Specifically, the present technology provides systems and methods for improved network quality testing techniques. In an example, the time stamping may be performed by component(s) of a server other than a NIC, and an internal portion of the duration may be estimated and apportioned to determine a duration associated with components external to the server (e.g., a network quality duration).

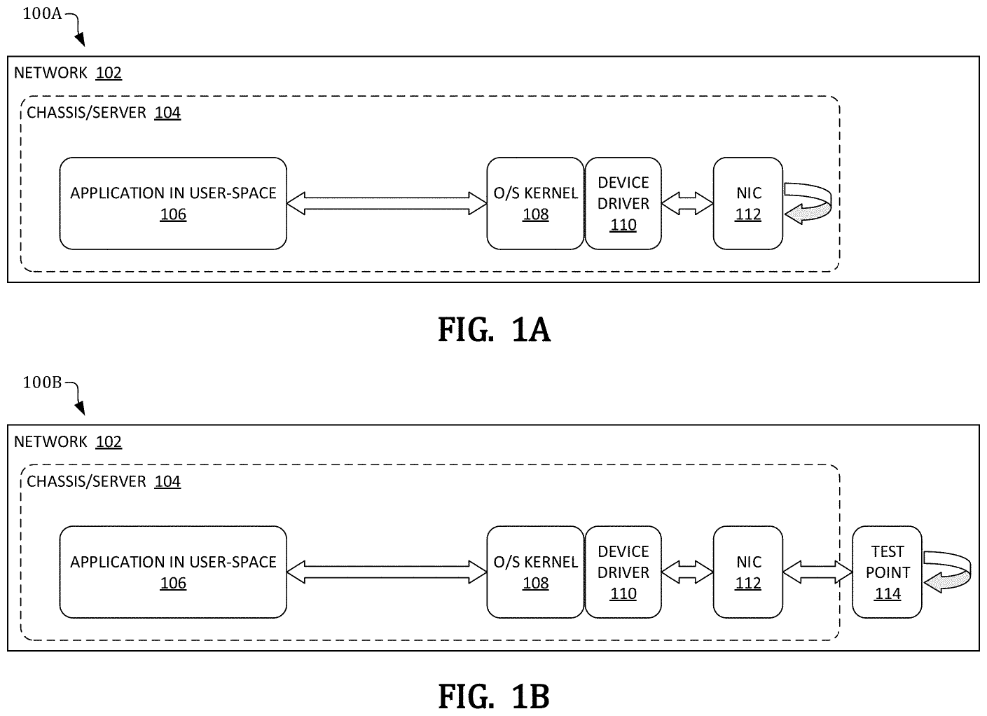

FIG. 1A depicts an example system 100A for quality testing of a network. The system 100A may include a network 102 and a server 104 (or chassis 104) on the network 102. The server 104 may include an application 106, a kernel 108, a device driver 110, and a network interface card 112 (NIC 112).

The network 102 may include other components or devices not shown in FIG. 1A. For example, the network 102 may include other servers or devices, test points, routers, gateways, switches, hubs, bridges, modems, repeaters, access points, etc. These network components (not shown) may be connected to each other and/or to the server 104, via a wired or wireless connection. Components of the network 102 may communicate over the network 102 and may pass traffic between each other over the network 102.

The server 104 may also include other components not shown in FIG. 1A. For example, the server 104 may also include drives, processors, memory, power supplies, adapters, other NICs, etc. The server 104 may be associated with local, internal IP address(es) identifying the server 104. For example, traffic sent to an internal IP address of the server 104 may be both sent from and received by the server 104. In addition to receiving traffic, the server 104 may send traffic to a destination (which may be internal to the server 104 or external to the server 104, as further described herein).

As indicated by the flow arrows in FIG. 1A, traffic (e.g., a packet) may be sent in a flow path internal to the server 104. The traffic described herein may be synthetic traffic. Synthetic traffic may include traffic that is directed to diagnostics, replicating behavior(s), or to serve a purpose other than delivering packet contents. Synthetic traffic may be light, non-intrusive, and secure. The traffic may originate at the application 106. The application 106 may be in a user space. The traffic may flow from the application 106 to a kernel 108, a device driver 110, and a NIC 112. In the example shown in FIG. 1A, the traffic is looped back to the server 104 at the NIC 112 (e.g., the flow path is internal to the server 104). The traffic then flows back through the device driver 110, the kernel 108, and to the application 106. The traffic may be directed back into the server 104 based on a destination of the traffic. In examples, the traffic may be sent to an IP address associated with the server 104 (e.g., a local IP address), a specific IP address associated with a loopback mechanism (e.g., a special purpose IP address for loopback traffic, such as 127.0.0.1), a localhost address, or other destination associated with directing traffic back into the server 104. When traffic originates from the server 104 and is looped back to the server 104 (e.g., without leaving the server 104), the traffic travels a flow path referred to herein as an internal flow path.

A duration of the internal flow path of traffic (e.g., a packet or packets) may be measured. The duration may include the entire flow path (e.g., from origination of the traffic at the application 106 until the traffic is received back at the application 106 post-loopback) or a portion of the traffic flow path (e.g., the round-trip time from kernel 108 back to the kernel 108, round-trip time from device driver 110 back to the device driver 110, time from the kernel 108 to the application 106, etc.). The duration of the internal flow path (e.g., the entire flow path or a portion of the flow path) may be determined based on time stamps associated with when traffic is sent from or received by one or more components of the server 104. For example, the kernel 108 may record a time stamp when the kernel 108 sends traffic (e.g., when traffic is received by the kernel 108 from the application 106 and is passed towards the NIC 112) and may also time stamp when the kernel 108 receives traffic (e.g., when traffic is received by the kernel 108 from the device driver 110 and is passed towards the application 106). A duration may be calculated based on the difference between the time stamps. Although the previous example describes time stamping by the kernel 108, time stamping and measuring and/or determining a duration of traffic for a flow path may be performed by other components of the server 104 (e.g., the application 106, the device driver 110, the NIC 112, or a combination of components). Some of the components of the server 104, may not have time stamping capabilities, however, such as the NIC 112.

The duration of the internal flow path (e.g., as shown in FIG. 1A) may be variable. For example, a duration of the internal flow path may vary from server-to-server, network-to-network, or within a single server 104. In an instance, the duration may be based on which components are included in a server 104, which components of a server perform time stamping, an amount of traffic being handled by the server at a given time, age or quality of components of the server 104, etc. The duration may be measured in milliseconds.

In an example where the server 104 includes multiple potential flow paths, a duration may be determined for each potential flow path. For example, if the server 104 includes multiple NICs 112, traffic may be programmed to test a first internal flow path through the first NIC and a second internal flow path through the second NIC. Durations for each flow path may be recorded and/or stored separately for reference in network quality testing. In another example, each NIC 112 available on the server 104 may be specifically targeted for use (e.g., in a configuration file, etc.). For instance, if the server 104 includes two NICs 112 (e.g., eth0 and eth1), each NIC may be specified to perform independent calculations relating to network quality testing.

FIG. 1B depicts an example system 100B for quality testing between the server 104 of FIG. 1A and a test point 114 in the network 102. The test point 114 may be external to the server 104 in the network 102. In the example shown in FIG. 1B, components of the server 104 and/or the network 102 may be simplified for purposes of discussion. Other components not shown, however, may exist in the server 104 and/or network 102, such as routers, gateways, switches, etc.

In contrast to FIG. 1A, FIG. 1B shows flow arrows of a packet flow path that includes flow to the test point 114 external to the server 104 on the network 102. The flow path shown in FIG. 1B may otherwise be referred to herein as an external flow path. In the external flow path, the traffic may flow from the application 106 to the kernel 108 to the device driver 110 to the NIC 112 and outside of the server 104 to the test point 114. The traffic is then returned through the NIC 112, device driver 110, kernel 108, and application 106. The external flow path, as shown, includes two components or portions: a portion attributable to an internal flow path (e.g., flow between the application 106 and the NIC 112, in either direction) and a portion attributable to an external flow path (e.g., flow between the NIC 112 and the test point 114, in either direction).

A duration of the external flow path in FIG. 1B thus includes a flow of the packet through components external to the server 104 (e.g., test point 114, routers, gateways, switches, etc.). The portion of the duration of the external flow path between the NIC 112 and the test point 114 is associated with network quality (otherwise referred to herein as a network quality duration). As also described above, the external duration may be measured in the same units as the duration of the internal flow path (e.g., in milliseconds).

Although a test point 114 is shown in the example in FIG. 1B, any destination for traffic on the network 102 and external to the server 104 may be included to test network quality. For example, test point 114 may be a device or a server different from server 104 on the network 102.

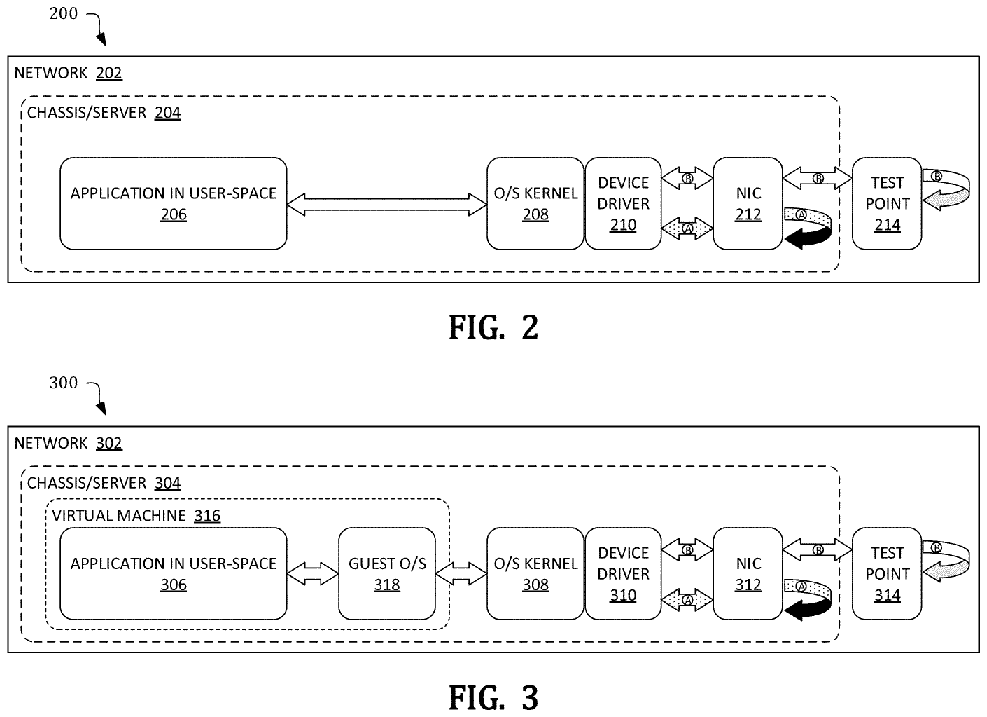

FIG. 2 depicts an example system 200 for quality testing a network 202. The system 200 may include components similar to those described with respect to FIGS. 1A-1B. For example, the system 200 includes a network 202. A server 204 and a test point 214 may exist within the network 202. Components of the server may include an application 206, a kernel 208, a device driver 210, and a NIC 212. As otherwise described, the network 202 and/or the server 204 may include other components not shown.

FIG. 2 shows two flow paths of traffic in the network 202, indicated by labelling of “A” and “B” on the flow arrows. Flow path A may be similar to the flow path described in FIG. 1A. Flow path B may be similar to the flow path described in FIG. 1B. By sending traffic (e.g., synthetic traffic of packets used for network quality testing) through both flow paths in a network 202, the network 202 may be quality tested. For example, network quality may be indicated by a duration of traffic between the NIC 212 and the test point 214. To isolate the network quality portion of flow path B (e.g., the duration of flow path B between thee NIC 212 and the test point 214), the total duration of flow path B may be compared with the duration of flow path A.

By comparing the duration of flow path B and flow path A, components of the server 204 contributing to the flow path B duration may be removed from a network quality determination. For example, the duration of flow path A may be subtracted from flow path B to determine a portion of flow path B associated with network quality. As described alternatively, a network quality duration (e.g., flow path between the NIC 212 and the test point 214) may be determined by measuring a duration of flow path A and flow path B and apportioning or attributing the duration of flow path B between components that are either internal to the server 204 (e.g., associated with flow path A) or external to the server 204 (e.g., associated with the network quality duration).

The duration of traffic through flow path A and/or flow path B, as further described herein, may be based on time stamping by one or more components of the server 204 that is capable of performing time stamping. For example, time stamping may be performed by the kernel 208 and/or application 206 when traffic is sent and received. In an example, time stamping by components positioned closer to the NIC 212 along the traffic flow path may be preferable to components positioned further away from the NIC in the traffic flow path. For instance, based on the example server 204 shown in FIG. 2, time stamping by the kernel 208 may be desirable over time stamping by the application 206 in part due to fewer components included in flow path A, which may reduce variability among durations measured for flow path A of the server 204.

As described above, a portion of flow path B is attributable to components of the server 204 (e.g., as indicated by flow path A), which may be variable. Thus, estimating the network quality duration portion of flow path B (e.g., the portion of flow path B not attributable to the internal components of the server 204) may present a challenge.

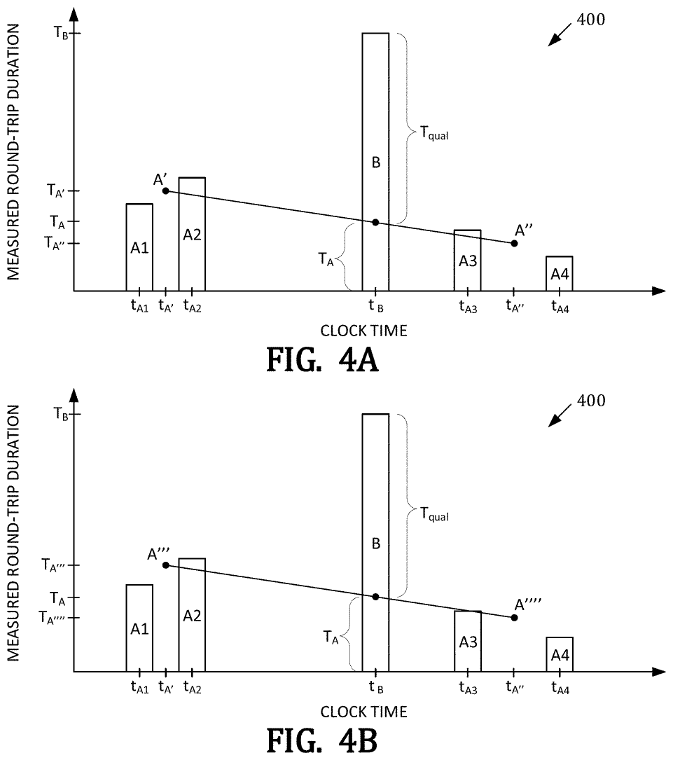

To apportion a percentage or portion of the duration of flow path B (e.g., the external duration) to the network quality duration, the duration of flow path A may be estimated at the time the external duration is measured. Due to variability in the duration of flow path A at a given time, the duration of flow path A may be measured proximate to the external duration and/or multiple measurements may be taken for the duration of flow path A at different times to otherwise estimate an internal duration at the time of measuring the external duration. For example, a duration of flow path A may be measured directly before or directly after a time (e.g., within a second, half a second, quarter of a second, a few milliseconds, etc.) of measuring the external duration (e.g., duration of flow path B). In another example, a duration for flow path A may be measured before and after measuring the external duration (e.g., sandwiching the time at which the external duration is measured) to determine an average duration or weighted average duration for the duration of flow path A at the time of measuring the external duration. Other examples for estimating the duration of flow path A are described with respect to FIGS. 4A-4B, 5, and 6, below.

The time at which the internal duration (e.g., duration of flow path A) and the external duration (e.g., duration of flow path B) are measured may be the time when a test packet is either sent from, or received by, the time stamping component of the server (e.g., application, kernel, etc.). For example, the time at which a duration is measured may be when a kernel of the server sends the test packet (e.g., when the test packet leaves the kernel to flow towards an interface card or a test point). Alternatively, the time at which a duration is measured may be when a kernel of the server receives the test packet (e.g., when the test packet returns to the kernel from an interface card or a test point). Any time in between the two time stamps (such as an average time) may also be used as the time at which a round-trip duration is measured. Note that an origination time of the test packet (e.g., when the test packet is generated by an application of the server) may be different from the time at which a round-trip duration of the test packet is measured. For example, a test packet may originate at an application of the server at an origination time and may be time stamped by a kernel of the server at a later time (e.g., when the kernel sends or receives the test packet, or a time in between). The time stamp(s) by the kernel, which are different than the origination time of the test packet at the application, may be used as the time at which the round-trip duration of the test packet is measured.

Estimating a duration of flow path A may be based on a machine learning model. For example, an accurate measure of the network quality duration may be determined for a server 204 having a NIC 212 with time stamping capabilities. An estimated network quality duration (e.g., as may be determined by subtracting an estimated duration of flow path A from a measured external duration) may be compared with the directly measured network quality duration (e.g., time stamping by the NIC 212 along flow path B). The comparison may be used by a machine learning model to improve estimations of the duration of flow path A. This may be on a server-by-server basis, path-by-path basis within a server, or network-by-network basis. In an example, some servers 204 may be capable of optimizing traffic directed to a loopback, which may result in immediate bounce-back of traffic (e.g., the duration of flow path A could be effectively recorded as zero milliseconds or a duration less than a threshold). In such an example, durations for flow path A may not be considered when estimating an internal duration portion of the external duration when the duration is less than a threshold duration (which may be server-dependent, path-dependent, network-dependent, etc.).

FIG. 3 depicts another example system 300 for quality testing a network 302. FIG. 3 includes components that may be similar to those described with respect to FIGS. 1A-1B and FIG. 2. For example, the system 300 includes a network 302. A server 304 and a test point 314 may be included within the network 302. Components of the server 304 may include an application 306, a kernel 308, a device driver 310, and a NIC 312. As otherwise described, the network 302 and/or the server 304 may include other components not shown. In contrast to FIG. 2, the system 300 in FIG. 3 shows a virtual machine 316 hosted on the server 304. The virtual machine 316 includes the application 306 and may also include a guest operating system 318. In this example system 300, flow path A and flow path B may differ from the flow paths described above prior to the kernel 308. For example, rather than the flow paths originating from an application (e.g., application 106, 206) and flowing directly to the kernel 308, the flow path may originate from application 306 on the virtual machine 316 and flow through the guest operating system 318 of the virtual machine 316 to the kernel 308.

If time stamping is performed by the kernel 308, then the durations of flow path A and flow path B in FIG. 3 may be similar to those described with respect to FIG. 2. Alternatively, if time stamping is performed by the application 306 on the virtual machine 316, then durations of the flow paths may be attributable to different components of FIGS. 2 and 3 (e.g., the flow paths in FIG. 3 may include duration attributable to the guest operating system 318). Thus, flow paths and durations of the flow paths may vary with different server configurations.

FIGS. 4A-4B, 5, and 6 depict graphical examples 400, 500, 600 of estimating quality of a network. The graphical examples 400, 500, 600 show a measured round-trip duration versus clock time. In the graphical examples 400, 500, 600, at least one data point is included for a measured duration internal to a server and one data point is included for a measured external duration for the same server. Although specific quantities of measured durations are shown, any number of measured durations, either internal to the server or external to the server, may be performed.

As further described herein, a duration of an internal flow path (e.g., a duration of flow of traffic along flow path A described in FIGS. 2-3 and flow described in FIG. 1A) may vary over time. Measured durations of traffic along the internal flow path are indicated by “A” in the graphical examples shown in FIGS. 4A-4B, 5, and 6 (e.g., A1, A2, A3, A4, A). As also described herein, an external duration (e.g., a duration flow of traffic along flow path B described in FIGS. 2-3 and flow in FIG. 1B) includes a portion attributable to a network quality testing duration (e.g., a duration apportioned to flow of traffic between a NIC of a server and a test point external to the server, referenced as T_{qual} in FIGS. 4A-4B, 5, 6). The external duration also includes a portion attributable to internal components of the server (referenced as T_{A} in FIGS. 4A-4B, 5, 6).

The graphical example 400 of FIGS. 4A-4B includes an external flow path test B, with duration T_{B} measured at time t_{B}. The graphical example 400 also includes four internal flow path tests A1, A2, A3, and A4, with durations measured at times t_{A1}, t_{A2}, t_{A3}, and t_{A4}, respectively. The duration T_{B} of the external flow path test B is apportioned to a network quality duration portion T_{qual} and an internal duration portion T_{A} at time t_{B}. To determine the amount of measured round-trip duration of the external flow path test B attributable to the internal duration, the four internal flow path tests A1, A2, A3, and A4 may be considered (e.g., if the internal flow path test meet or exceed at least a minimum threshold duration, such as to ensure no direct bounce-back of a test).

In FIG. 4A, the internal duration portion T_{A} of the external flow path test B at time t_{B} is determined by averaging sets of internal flow path tests. In particular, in FIG. 4A, the durations of the internal flow path tests measured prior to the external flow path test B at time t_{B} are averaged (e.g., internal flow path tests A1 and A2 at times t_{A1} and t_{A2}, which occur prior to time t_{B}) (e.g., the first average duration T_{A′} at time t_{A′}, the average time of t_{A1} and t_{A2}) and the durations of the internal flow path tests measured after the external flow path test B at time t_{B} (e.g., internal flow path tests A3 and A4 at times t_{A3} and t_{A4}, which occur after time t_{B}) (e.g., the second average duration T_{A″} at time t_{A″}, the average time of t_{A3} and t_{A4}) are averaged. The two averages (T_{A′} at time t_{A′} and T_{A″} at time t_{A″}) may be weighted according to clock time relative to time t_{B} to estimate an internal duration portion T_{A} at time t_{B}. In an example, the weighted average (T_{A}) of the two averages (T_{A′} and T_{A″}) is determined based on a value along a line connecting the two averages at clock time t_{B}.

FIG. 4B also determines an estimated internal duration portion T_{A} at time t_{B} using a weighted average of sets of internal flow path tests. Unlike FIG. 4A, however, FIG. 4B takes a weighted average of each set of internal flow path tests at an average time of each set. For example, the internal flow path tests measured before the external flow path test B at time t_{B} (e.g., internal flow path tests A1 and A2 at times t_{A1} and t_{A2}) may be weighted based on clock time relative to time t_{B}. For instance, internal flow path test A2 may be weighted more because internal flow path test A2 is measured closer to time tB than internal flow path test A1. Similarly, internal flow path test A3 may be weighted more than internal flow path test A4 because internal flow path test A3 is measured closer to time tB than internal flow path test A4. The two weighted averages (T_{A′″} and T_{A″″}) may then be used to determine an estimated internal duration portion T_{A} at time t_{B} (e.g., based on a value along a line connecting the two weighted averages at clock time t_{B}).

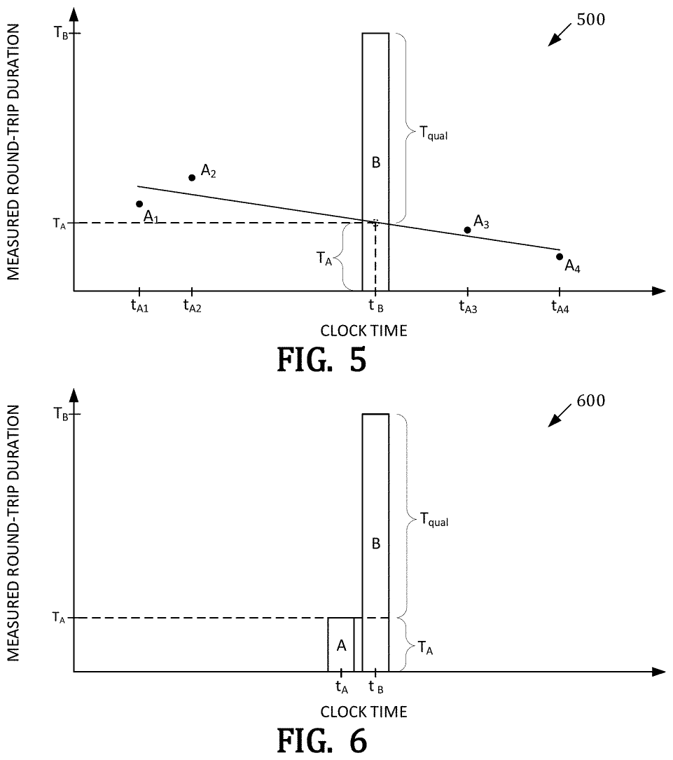

The graphical example 500 in FIG. 5 may include tests similar to those described with respect to FIGS. 4A-4B. For example, the graphical example 500 includes an external flow path test B, with duration T_{B} measured at time t_{B}. Additionally, the graphical example 500 includes four internal flow path tests A1, A2, A3, and A4, with durations measured at times t_{A1}, t_{A2}, t_{A3}, and t_{A4}, respectively. In FIG. 5, the estimated internal duration portion T_{A} of the external flow path test B is determined using a regression analysis or best fit analysis of the measured durations of the internal flow path tests A1, A2, A3, and A4 over time. The value of the regression analysis or best fit analysis at time t_{B} is the estimated internal duration portion T_{A}.

The graphical example 600 in FIG. 6 includes an external flow path test B, with duration T_{B} measured at time t_{B} and an internal flow path test A, with duration T_{A} measured at time t_{A}. In this example, the measured duration of the internal flow path test A is the same as the estimated internal duration portion T_{A} of the external duration T_{B}. This may result when only one internal flow path test A is measured. Alternatively, this may result when an internal flow path test A is determined to be a reliable estimate of the internal duration portion T_{A} (e.g., if the internal flow path test A was measured at a time t_{A} very close to the external flow path test B, such as within half a second, a few milliseconds, etc.).

In each of the graphical examples 400, 500, 600 provided in FIGS. 4A-4B, 5, and 6, a network quality duration portion T_{qual} of the measured duration T_{B} of the external flow path test B is determinable based on the estimated internal duration portion T_{A} and the measured duration T_{B} of the external flow path test B. For example, the estimated internal duration portion T_{A} may be subtracted from the measured duration T_{B} of the external flow path test B to calculated the network quality duration portion T_{qual}. The estimated internal duration portion T_{A} may otherwise be modified based on machine learning, directly measured or known network quality durations (e.g., as determined with a NIC capable of time stamping), or other information to correct for inaccuracies in the estimated internal duration portion T_{A}.

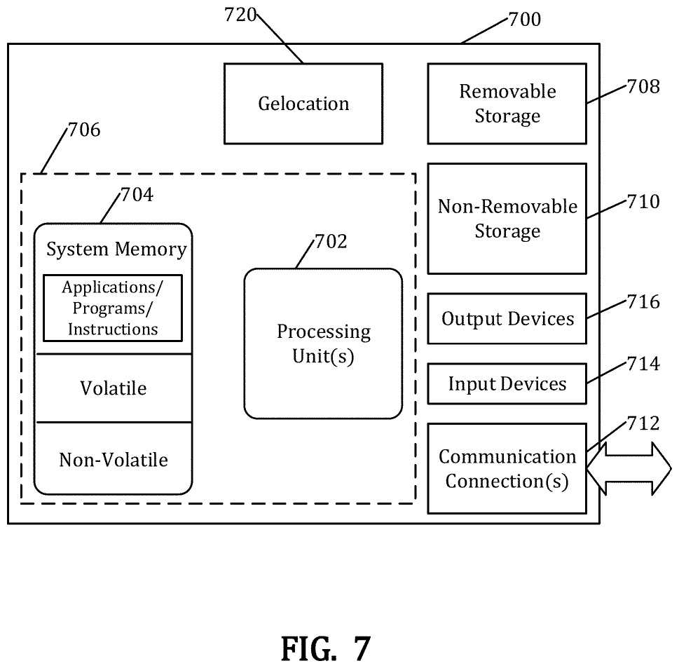

FIG. 7 depicts an example of a suitable operating environment 700 that may be implemented by a client device, system or server, and/or other computing devices within the systems discussed herein. In its most basic configuration, operating environment 700 typically includes at least one processing unit 702 and memory 704. The processing unit may be a processor, which is hardware. Depending on the exact configuration and type of computing device, memory 704 (storing, instructions to perform the motion detection techniques disclosed herein) may be volatile (such as RAM), non-volatile (such as ROM, flash memory, etc.), or some combination of the two. This most basic configuration is illustrated in FIG. 7 by dashed line 706. The memory 704 stores instructions that, when executed by the processing unit(s) 702, perform the processes and operations described herein, such as testing network quality, etc. Further, environment 700 may also include storage devices (removable 708, and/or non-removable 710) including, but not limited to, solid-state, magnetic disks, optical disks, or tape. Similarly, environment 700 may also have input device(s) 714 such as keyboard, mouse, pen, voice input, etc. and/or output device(s) 716 such as a display, speakers, printer, etc. Additional communication connections 712 may also be included that allow for further communication with LAN, WAN, point-to-point, etc. Operating environment 700 may also include geolocation devices 720, such as a global positioning system (GPS) device.

Operating environment 700 typically includes at least some form of computer readable media. Computer readable media can be any available media that can be accessed by processing unit 702 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

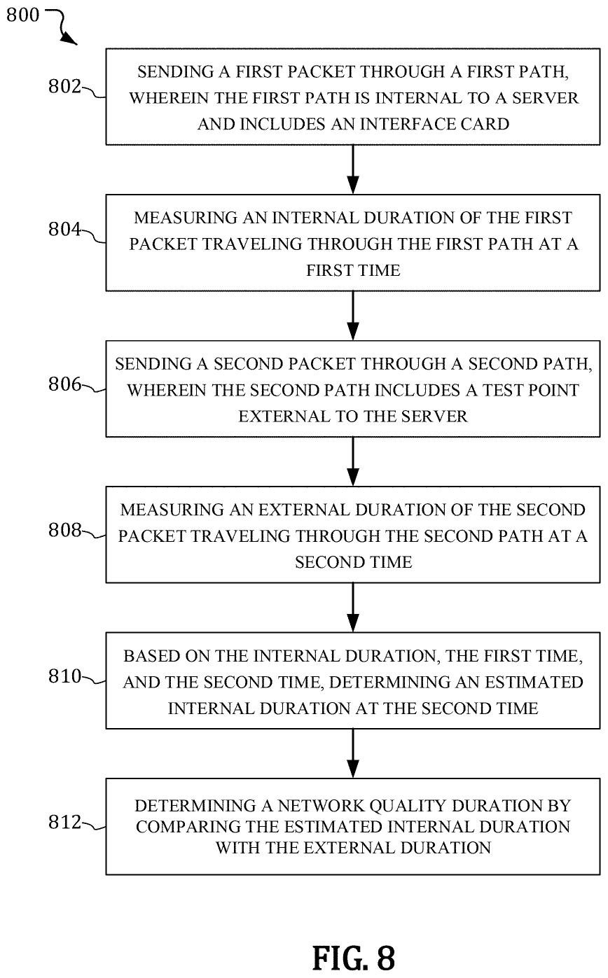

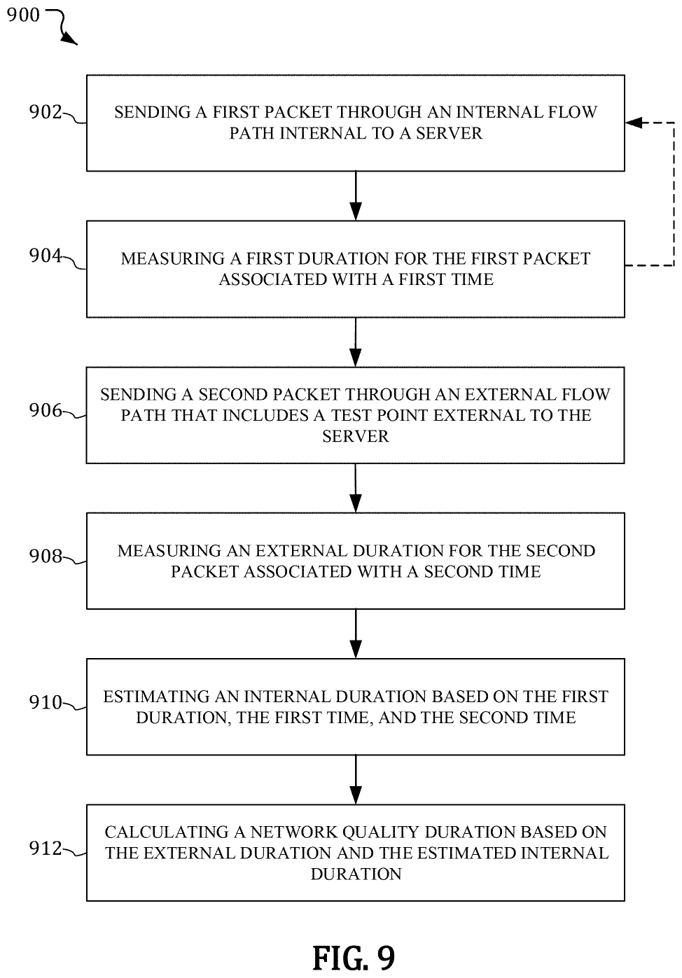

FIGS. 8-9 show flow charts depicting example methods for quality testing a network. The example methods include operations that may be implemented or performed by the systems and devices disclosed herein. For example, at least systems 100A, 100B, 200, and 300 depicted in FIGS. 1A-1B, 2, and 3 may perform the operations described herein. In addition, instructions for performing the operations of the methods disclosed herein may be stored in a memory of a one or more of the systems or devices (e.g., memory 704 in FIG. 7).

FIG. 8 shows a flow chart illustrating a method 800 for quality testing a network (e.g., network 102, 202, 302). At operation 802, traffic (e.g., a test packet) is sent through a first path. The first path may be completely internal to a server. For example, the first path may flow through components of a server and be looped back to the server at an interface card (e.g., flow path A in FIGS. 2-3). The loop back of the first packet into the server may be based on a destination of the first packet. For example, the destination may be an IP address internal or local to the originating server, an IP address associated with loopback (e.g., 127.0.0.1), a local host, etc. As described above, the first path, internal to the server, may include flow through a kernel, a device driver, and an interface card of the server. The server may also include an application that may be user-facing. The first packet may originate from the application. Additionally, the first packet may be synthetic traffic.

At operation 804, an internal duration of the first packet traveling through the first path is measured at a first time. The internal duration may be measured based on time stamping. For example, the internal duration may be a difference between a first time stamp and a second time stamp associated with the first packet by a component of the server. For example, a kernel and/or application of the server may perform the time stamping. In an instance, a first time stamp may be recorded by the kernel as the first packet flows from the kernel towards an interface card of the server and a second time stamp may be recorded by the kernel as the first packet flows from the interface card towards the kernel. The time at which the internal duration is measured may be at the first time stamp, the second time stamp, or a time in between the two time stamps.

At operation 806, a second packet is sent through a second path. The second path may include a portion that is external to the server. For example, the second path may include flow from a server to an external test point. The server may communicate the second packet to the test point via an interface card of the server. The server and the test point may be in the same network.

The first packet and the second packet may have similar characteristics. For example, the first packet and the second packet may have the same size, payload, protocol, and/or any other characteristic that may influence a duration of a packet to reach a destination (e.g., time-variable packet characteristics). Alternatively, the first packet and second packet may differ in one or more characteristics. In an example where the first packet and the second packet differ in one or more time-variable packet characteristic, the impact on travel duration of a packet may be correlated. For instance, given no other time-variability along a given flow path for a packet, a difference between a first duration for a first packet with a smaller payload and a second duration for a second packet with a larger payload may be correlated (e.g., based on the size difference in the payloads). Thus, if the first packet described in operation 802 and the second packet described in operation 806 have different characteristics, time-variability in durations associated with the characteristic differences may be pre-determined or otherwise correlated.

At operation 808, an external duration of the second packet traveling through the second path is measured at a second time. Measuring of the external duration may be similar to measuring the internal duration described in operation 804. For example, the external duration may be based on time stamping by components of the server (e.g., the kernel and/or application) when the second packet is sent from and received by the component(s). If the second packet has different time-variable packet characteristics from the first packet, then an adjustment may be made to either the measured internal duration or the measured external duration based on a pre-determined or correlated time-variability associated with the difference in characteristics.

At operation 810, based on the measured internal duration, the first time, and the second time, an estimated internal duration is determined at the second time. As described herein, the external duration may include a portion attributable to an internal flow path and a portion attributable to a network quality duration. The estimated internal duration (e.g., the portion of the external duration attributable to an internal flow path) may be based on the internal duration measured at operation 804 and proximity of the measured internal duration (e.g., at the first time) to the measured external duration (e.g., at the second time). The estimation of the internal duration at the second time may be based on averages, weighted averages, machine learning algorithms, other measurements of internal duration, etc.

At operation 812, a network quality duration is determined by comparing the estimated internal duration with the external duration. Comparing the estimated internal duration with the external duration may include subtracting the estimated internal duration from the external duration.

FIG. 9 shows a flow chart illustrating a method 900 for quality testing a network (e.g., network 102, 202, 302). At operation 902, a first packet is sent through a first flow path internal to a server. Operation 902 may be similar to that of operation 802 described in FIG. 8. For example, the first flow path may be completely internal to a server such that a packet is looped back into the server at an interface card. Examples of a first flow path internal to a server are described at least with respect to FIG. 1A, and FIGS. 2-3 (e.g., flow path A).

At operation 904, a first duration is measured for the first packet associated with a first time. As further described herein, the first duration may be measured based on time stamping of one or more components of the server (e.g., kernel, application, etc.). This operation 904 may be similar to that of operation 804 described in FIG. 8.

Operations 902-904 may repeat as required or desired. For example, multiple tests of the internal flow path (e.g., first flow path) of the server may be performed by sending packets through the first flow path at different times. For example, two, three, four, or five or more different packets may be sent through the first flow path. The tests of the first flow path may be timed according to sending a packet though an external flow path, as described in operation 906). For example, a first internal packet may be sent through the first flow path at a first time, before an external packet is sent through the external flow path, and a second internal packet may be sent through the first flow path at a second time, after the external packet is sent through the external flow path (e.g., sandwiching the external flow path test with at least two tests of the internal flow path). For each test of the internal flow path, a duration of the test is associated with the time at which the test was performed (e.g., a first test at a first time, a second test at a second time, a third test at a third time, etc.).

Operations 906-908 may be similar to operations 806-808 in FIG. 8. At operation 906, a second packet is sent through an external flow path. The external flow path may include a test point external to the server. The server may communicate the second packet to the test point via an interface card of the server. The server and the test point may be in the same network. At operation 908, an external duration is measured for the second packet associated with a second time. The external duration may be based on time stamping by components of the server (e.g., the kernel and/or application) when the second packet is sent from and received by the component(s).

At operation 910, an internal duration is estimated. The estimated internal duration may be based on the measured first duration, the first time, and the second time. The estimation of the internal duration at the second time may be based on averages, weighted averages, machine learning algorithms, other measurements of internal duration, etc. In an example when multiple tests are performed for the internal duration (e.g., repeating of operations 902-904), the estimated internal duration may be further based on durations measured at other times. For example, a first test at a first time with a first duration and a second test at a third time with a third duration may be weighted according to proximity of the first time and the third time (of the tests) relative to the second time (of the measured external duration at operation 908). For instance, the first test and the second test durations may be weighted relative to each other according to a gap between the first time and the second time and a gap between the third time and the second time, respectively. Other examples of estimating the internal duration are further described at least with respect to FIGS. 4A-4B, 5, and 6.

At operation 912, a network quality duration is calculated based on the external duration and the estimated internal duration. In an example, the network quality duration is calculated by subtracting the estimated internal duration from the external duration.

The network quality duration described in operation 812 and 912 of FIGS. 8 and 9, respectively, may be used or otherwise evaluated with respect to quality of a network. For example, the network quality duration may be reported out (e.g., to a different server or device on the network or to a different network). When evaluating the network quality duration, a shorter network quality duration may be associated with better network quality and a longer network quality duration may be associated with a lesser network quality.

Additionally or alternatively, the network quality duration may be verified for accuracy or otherwise validated. In an example, the network quality duration (as calculated or determined in operations 812 and 912) may be checked against a measured or known network quality duration. The network quality duration may be measured or known based on time stamping by an interface card of the server (e.g., with an interface card capable of time stamping). Comparison or verification with a measured or known network quality duration may be used to better estimate an internal duration (e.g., as described with respect to operations 810 and 910 in FIGS. 8 and 9, respectively). For example, machine learning algorithms may be implemented and trained for accuracy of the estimated internal duration.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art. Further, as used herein and in the claims, the phrase “at least one of element A, element B, or element C” is intended to convey any of: element A, element B, element C, elements A and B, elements A and C, elements B and C, and elements A, B, and C. Further, one having skill in the art will understand the degree to which terms such as “about” or “substantially” convey in light of the measurements techniques utilized herein. To the extent such terms may not be clearly defined or understood by one having skill in the art, the term “about” shall mean plus or minus ten percent.

Although specific embodiments are described herein, the scope of the technology is not limited to those specific embodiments. Moreover, while different examples and embodiments may be described separately, such embodiments and examples may be combined with one another in implementing the technology described herein. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A computer-implemented method for testing network quality, the computer-implemented method comprising:
sending a first packet through a first path, wherein the first path is internal to a server and includes an interface card;
measuring an internal duration of the first packet traveling through the first path at a first time;
sending a second packet through a second path, wherein the second path includes a test point external to the server;
measuring an external duration of the second packet traveling through the second path at a second time;
based on the measured internal duration, the first time, and the second time, determining an estimated internal duration at the second time; and
determining a network quality duration by comparing the estimated internal duration with the external duration.

2. The computer-implemented method of claim 1, wherein comparing the estimated internal duration with the external duration includes subtracting the estimated internal duration from the external duration.

3. The computer-implemented method of claim 1, wherein the first path further includes a kernel and a device driver.

4. The computer-implemented method of claim 3, wherein the measured internal duration is determined based on a first time stamp recorded by the kernel as the first packet flows from the kernel to the interface card and a second time stamp recorded by the kernel as the first packet flows to the kernel from the interface card.

5. The computer-implemented method of claim 4, wherein the first time is when the kernel records the first time stamp.

6. The computer-implemented method of claim 5, wherein the external duration is measured based on a third time stamp recorded by the kernel as the second packet flows from the kernel to the test point and a fourth time stamp recorded by the kernel as the second packet flows to the kernel from the test point; and wherein the second time is when the kernel records the third time stamp.

7. The computer-implemented method of claim 1, further comprising:
reporting the network quality duration to a different server.

8. A computer-implemented method for testing network quality, the computer-implemented method comprising:
sending a first packet through an internal flow path internal to a server;
measuring a first duration for the first packet associated with a first time;
sending a second packet through the internal flow path;
measuring a second duration for the second packet associated with a second time;
sending a third packet through an external flow path, the external flow path including a test point external to the server;
measuring a third duration for the third packet associated with a third time;
estimating an internal duration associated with the third time, based on the first duration, the first time, the second duration, and the second time; and
calculating a network quality duration based on the third duration and the estimated internal duration.

9. The computer-implemented method of claim 8, wherein estimating the internal duration is further based on a weighted average of the first duration and the second duration.

10. The computer-implemented method of claim 9, wherein the weighted average is further based on a first time difference between the first time and the third time and a second time difference between the second time and the third time.

11. The computer-implemented method of claim 8, wherein the internal flow path includes a kernel, a device driver, and an interface card.

12. The computer-implemented method of claim 8, wherein sending the first packet through the internal flow path includes sending the first packet to one of:
an internet protocol (IP) address internal to the server;
an IP address at 127.0.0.1; or
a local host.

13. The computer-implemented method of claim 8, wherein measuring the first duration and the second duration is based on time stamping by a kernel of the server.

14. The computer-implemented method of claim 13, the method further comprising:
validating the network quality duration based on time stamps by an interface card of the server.

15. A system for testing network quality, the system comprising:
a test point; and
a server, the server including:
an interface card;
at least one processor; and
memory storing instructions that when executed by the at least one processor cause the system to perform a set of operations comprising:
sending a first packet through a first path, wherein the first path is internal to a server and includes an interface card;
measuring an internal duration of the first packet traveling through the first path at a first time;
sending a second packet through a second path, wherein the second path includes a test point external to the server;
measuring an external duration of the second packet traveling through the second path at a second time;
based on the measured internal duration, the first time, and the second time, determining an estimated internal duration at the second time; and
determining a network quality duration by subtracting the estimated internal duration from the external duration.

16. The system of claim 15, wherein the server further includes an application and a kernel, and wherein the first path includes the kernel, but not the application.

17. The system of claim 16, wherein the application is on a virtual machine on the server.

18. The system of claim 17, wherein the virtual machine also includes a guest operating system.

19. The system of claim 15, wherein the first path is a round trip path from a kernel of the server to the interface card to the kernel.

20. The system of claim 19, wherein the second path is a round trip path from the kernel through the interface card to the test point and back to the kernel through the interface card.
